(19) United States
(12) Patent Application Publication
(10) Pub. No.: US 2008/0104448 A1
(43) Pub. Date: May 1, 2008

(54) Testing apparatus for semiconductor device

(76) Inventor: Kenji Tamura, Tokyo (JP)

Correspondence Address: MURAMATSU & ASSOCIATES, Suite 310, 114 Pacifica, Irvine, CA, 92618, US

(21) Appl. No.: 11/589,518

(22) Filed: Oct. 30, 2006

(51) Int. Cl. G06F 11/00

(52) U.S. Cl. 714/40

(57) ABSTRACT

A testing apparatus for semiconductor device comprises test controllers 10-1, 10-2, . . . , 10-N, variable clock generators 24-1, 24-2, . . . , 24-N which are provided respectively associated with the test controllers 10-1, 10-2, . . . , 10-N and which output variable clock signals having certain phase relationships with the control signals outputted from the associated test controllers 10-1, 10-2, . . . , 10-N, test pin groups 12-1, 12-2, . . . , 12-N which synchronize with the variable clock signals and test devices under test based on the control signals, an N×N switch matrix 16 which supplies the control signal from the test controller 10-i of the test controllers 10-1, 10-2, . . . , 10-N to the test pin group 12-j assigned to the test controller 10-i, and an N×N switch matrix 18 which supplies to the test pin group 12-j the variable clock signal from the variable clock generator 24-i of the variable clock generators 24-1, 24-2, . . . , 24-N, which is associated with the test controller 10-i.

### BACKGROUND OF THE INVENTION

The present invention relates a testing apparatus for semiconductor device, more specifically, a testing apparatus for semiconductor device, which includes test pin groups to be assigned to test controllers.

The testing apparatus for semiconductor device, which judges the normality of semiconductor devices, such as semiconductor integrated circuits, etc. comprises a test controller which outputs a control signal, based on a test program, and a test pin group of a plurality of pin electronics cards which test devices under test (DUTs) as to the normality, etc. based on the control signal outputted from the test controller. The testing apparatus generally comprises a plurality of test controllers and a plurality of test pin groups.

FIG. 4 is a block diagram of a conventional testing apparatus comprising test pin groups formed of pin electronics cards which synchronize with a fixed clock signal, which illustrates a structure thereof.

As illustrated, the testing apparatus comprises N (N is a natural number of 2 or more) test controllers 100-1, 100-2, . . . , 102-N, N test pin groups 102-1, 102-2, . . . , 102-N, a fixed clock generator 104, and an N×N switch matrix 106. Each test pin group 102-1, 102-2, . . . , 102-N is formed of a plurality of pin electronic cards 108 which synchronize with a fixed clock signal. DUTs (not illustrated) are connected to the pin electronics cards 108.

The test controllers 100-1, 100-2, . . . , 100-N output, based on test programs, control signals for controlling the test of DUTs by the pin electronics cards 108 of the test pin groups 102-1, 102-2, . . . , 102-N.

Synchronization circuits 110-1, 110-2, . . . , 110-N are provided, respectively associated with the test controllers 100-1, 100-2, . . . , 100-N.

To the synchronization circuits 110-1, 110-2, 110-N, the control signals outputted from the associated test controllers 100-1, 100-2, . . . , 100-N are inputted. To the respective synchronization circuits 110-1, 110-2, 110-N, a fixed clock signal generated by the fixed clock generator 104 is inputted. The respective synchronization circuits 110-1, 110-2, . . . , 110-N output the control signals synchronized with the fixed clock signal inputted from the fixed clock generator 104. The control signals outputted from the respective synchronization circuits 110-1, 110-2, . . . , 110-N are inputted to the N×N switch matrix 106 which switches the control signals.

The test pin groups 102-1, 102-2, . . . , 102-N are assigned to the test controllers 100-1, 100-2, . . . , 100-N via the N×N switch matrix 106 which switches the control signals. To the test pin group 102-j (j is a natural number which satisfies 1≦j≦N) assigned to the test controller 100-i (i is a natural number which satisfies 1≦i≦N), the control signal from the test controller 100-i, which are synchronized with the fixed clock signal, is supplied via the N×N switch matrix 106. The assignment of the test pin groups 102-1, 102-2, . . . , 102-N to the test controllers 100-1, 100-2, . . . , 100-N is changed by switching the control signals by the N×N switch matrix 106.

The pin electronics cards 108 of the test pin groups 102-1, 102-2, . . . , 102-N each include a pattern generator (not illustrated) and a timing generator (not illustrated) for generating a test signal of a prescribed waveform at a prescribed timing to be inputted to the DUTs, and test the DUTs as to the normality, etc. The pin electronics cards 108 of the test pin group 100-j test the DUTs, based on the control signal from the assigned test controller 100-i. To the pin electronics cards 108 of the respective test pin group 102-1, 102-2, . . . , 102-N, the fixed clock signal generated by the fixed clock generator 104 is supplied. The pin electronics cards 108 operate in synchronization with the fixed clock signal supplied from the fixed clock generator 104.

As described above, in the conventional testing apparatus including the test pin groups 102-1, 102-1, . . . , 102-N each formed of the pin electronics cards 108 which synchronize with the fixed clock signal, all the control signals of the respective test controllers 100-1, 100-2, . . . , 100-N and all the operations of the pin electronics cards 108 of the respective test pin groups 102-1, 102-2, . . . , 102-N synchronize with the same fixed clock signal generated by the fixed clock generator 104. Since the signals and the operations synchronize with the same fixed clock signal in this way, even when the respective, controllers 100-1, 100-2, . . . , 100-N asynchronously start tests, the phase relationship between the control signals and the clock signal is always sustained. Accordingly, the assignment of the test pin groups 102-1, 102-2, . . . , 102-N to the test controllers 100-1, 100-2, . . . , 100-N can be changed by switching the control signals alone by the N×N switch matrix 106.

Recently, the test pin groups are often formed of pin electronic cards which synchronize with variable clock signals. In such case, it is difficult to sustain the phase relationship between the control signals and the clock signals by simply switching the control signals from the test controllers to thereby change the assignment of the test pin groups to the test controllers in the same way as the case shown in FIG. 4 where the pin electronic cards synchronize with the fixed clock signal.

### SUMMARY OF THE INVENTION

An object of the present invention is to provide a testing apparatus for semiconductor device which can assign test pin groups to test controllers on-line and control the respective test pin groups individually when the test pin groups are formed of pin electronics cards which synchronize with variable clock signals.

The above-described object is achieved by a testing apparatus for semiconductor device comprising: a plurality of controlling units which output control signals for testing devices under test; a plurality of variable clock generating units provided respectively associated with said plural controlling units, for outputting variable clock signals having certain phase relationships with the control signals outputted from the associated controlling units; a testing unit for testing the device under test based on the control signal, the testing unit synchronizing with the variable clock signal; a first switching means for supplying the control signal from one controlling unit of the plural controlling units to the testing unit which is assigned to said one controlling unit; and a second switching means for supplying to the testing unit the variable clock signal from one variable clock generating unit of the plural variable clock generating units, said one variable clock generating unit being associated with said one controlling unit.

In the above-described testing apparatus for semiconductor device, it is possible that the testing apparatus comprises a plurality of said testing units, one testing unit of said plural testing units is assigned to said one controlling unit, the first switching means supplies to said one testing unit the control signal from said one controlling unit, and the second switching means supplies to said one testing unit the variable clock signal from said one variable clock generating unit.

In the above-described testing apparatus for semiconductor device, it is possible that the testing apparatus comprises a plurality of said testing units, said plural testing units are assigned to said one controlling unit, the first switching means supplies to said plural testing units the control signal from said one controlling unit, and the second switching means supplies to said plural testing units the variable clock signal from said one variable clock generating unit.

In the above-described testing apparatus for semiconductor device, it is possible that the first switching means and the second switching means are respectively switch matrices having a plurality of inputs and a plurality of outputs.

According to the present invention, the testing apparatus for semiconductor device comprises: a plurality of controlling units which output control signals for testing devices under test; a plurality of variable clock generating units provided respectively associated with said plural controlling units, for outputting variable clock signals having certain phase relationships with the control signals outputted from the associated controlling units; a testing unit for testing the device under test based on the control signal, the testing unit synchronizing with the variable clock signal; a first switching means for supplying the control signal from one controlling unit of the plural controlling units to the testing unit which is assigned to said one controlling unit; and a second switching means for supplying to the testing unit the variable clock signal from one variable clock generating unit of the plural variable clock generating units, said one variable clock generating unit being associated with said one controlling unit, whereby the testing unit can be assigned to the controlling unit on-line and the testing unit can be controlled individually.

### BRIEF DESCRIPTION OF THE DRAWINGS

FIG. 1 is a block diagram of the testing apparatus for semiconductor device according to one embodiment of the present invention, which illustrates a structure thereof.

FIG. 2 is a block diagram of the structure of the testing apparatus for semiconductor device including test pin groups formed of pin electronics cards which synchronize with variable clock signals, wherein the variable clock signals are not switched, but control signals alone are switched.

FIG. 3 is a time chart of a control signal and a variable clock signal of the testing apparatus having the structure illustrated in FIG. 2.

FIG. 4 is the block diagram of the conventional testing apparatus for semiconductor device, which illustrates the structure thereof.

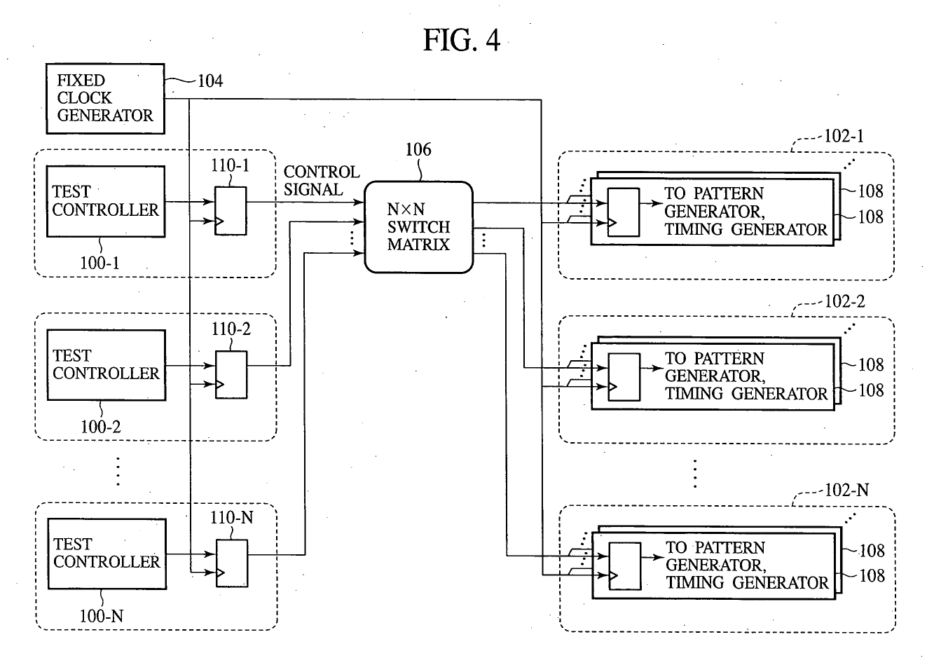

### DETAILED DESCRIPTION OF THE INVENTION

### One Embodiment

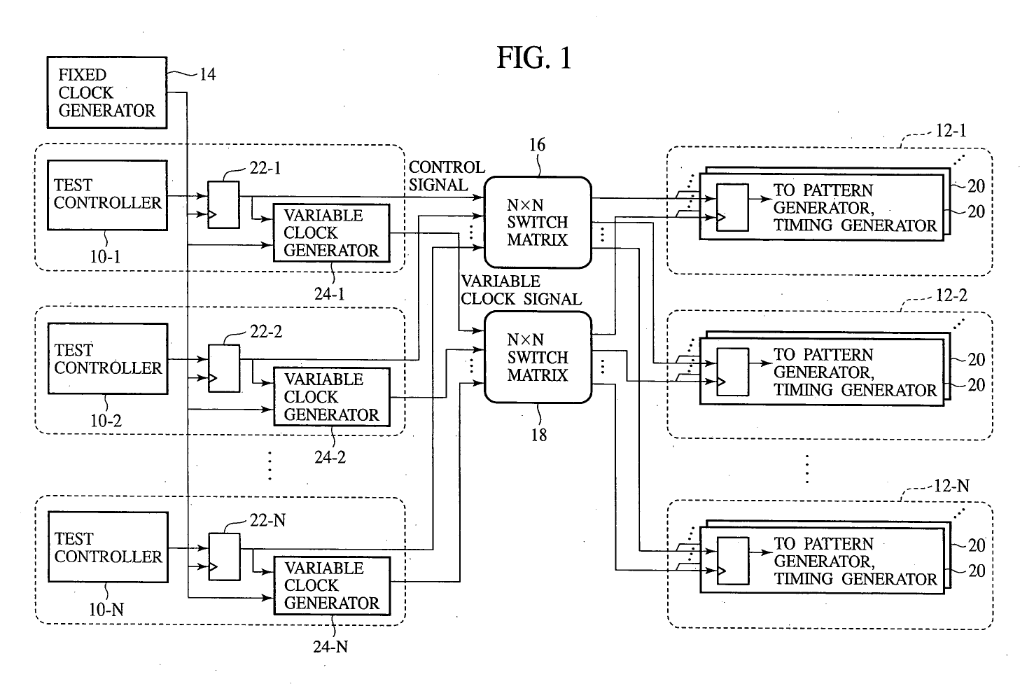

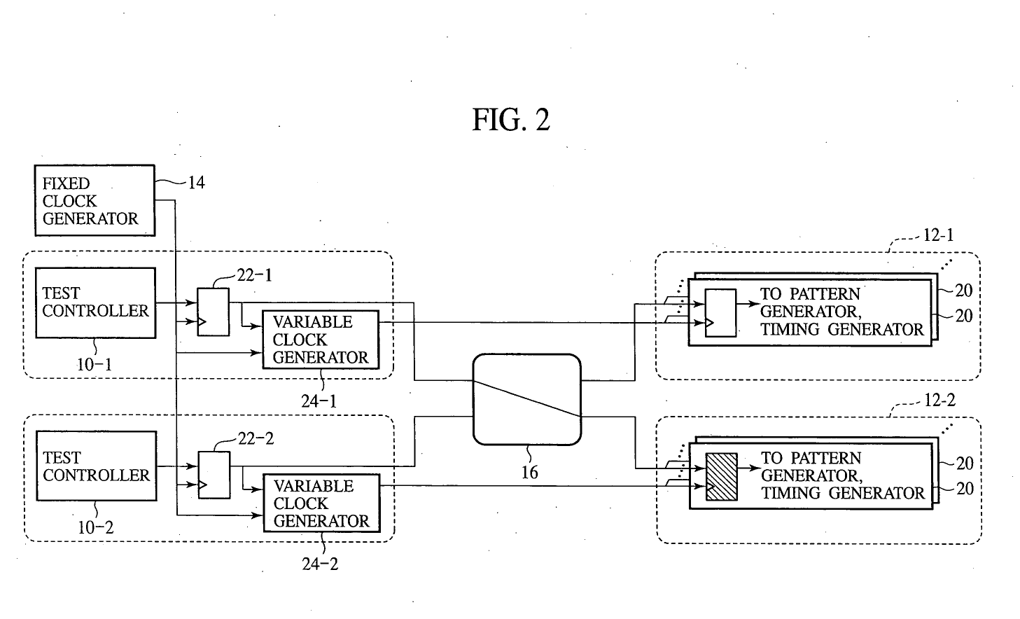

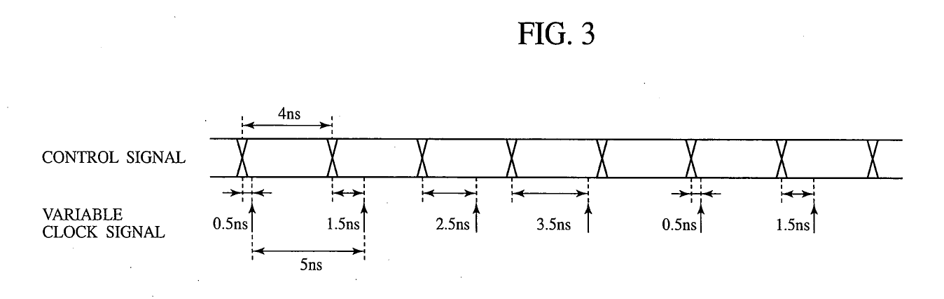

The testing apparatus for semiconductor device according to one embodiment of the present invention will be explained with reference to FIGS. 1 to 3. FIG. 1 is a block diagram of the testing apparatus for semiconductor device according to the present embodiment, which illustrates a structure thereof, and FIGS. 2 and 3 are views explaining a disadvantage of changing the assignment of test pin groups to test controllers by switching control signals alone.

As illustrated in FIG. 1, the testing apparatus for semiconductor device according to the present embodiment includes N (N is a natural number of 2 or more) test controllers 10-1, 10-2, . . . , 10-N, N test pin groups 12-1, 12-2, . . . , 12-N, a fixed clock generator 14, a switch matrix having N inputs and N outputs (N×N switch matrix) 16, and an N×N switch matrix 18. Each test pin groups 12-1, 12-2, . . . , 12-N is formed of a plurality of pin electronics cards 20 which synchronize with variable clock signals. DUTs (not illustrated) which are semiconductor devices, such as semiconductor integrated circuits, etc., are connected to the pin electronics cards 20.

The test controllers 10-1, 10-2, . . . , 10-N output, based on test programs, control signals for controlling the test of the DUTs by the pin electronics cards 20 of the test pin groups 12-1, 12-2, . . . , 12-N.

Synchronization circuits 22-1, 22-2, . . . , 22-N and variable clock generators 24-1, 24-2, . . . , 24-N are provided, respectively associated with the test controllers 10-1, 10-2, . . . , 10-N.

To the synchronization circuits 22-1, 22-2, . . . , 22-N, control signals outputted from the associated test controllers 10-1, 10-2, . . . , 10-N are inputted. To the respective synchronization circuits 22-1, 22-2, . . . , 22-N, a fixed clock signal generated by the fixed clock generator 14 is inputted. The respective synchronization circuits 22-1, 22-2, . . . , 22-N output the control signals synchronized with the fixed clock signal inputted from the fixed clock generator 14. The control signals outputted from the respective synchronization circuits 22-1, 22-2, . . . , 22-N are inputted to the N×N switch matrix 16 which switches the control signals and to the respective associated variable clock generators 24-1, 24-2, . . . , 24-N.

To the variable clock generators 24-1, 24-2, . . . , 24-N, control signals are inputted from the respective associated synchronization circuits 22-1, 22-2, . . . , 22-N. To the respective variable clock generators 24-1, 24-2, . . . , 24-N, the fixed clock signal generated by the fixed clock generator 14 is inputted. The respective variable clock generators 24-1, 24-2, . . . , 24-N output frequency variable clock signals having certain phase relationships with the control signals inputted from the respective associated synchronization circuits 22-1, 22-2, . . . , 22-N, based on the inputted control signals and the fixed clock signal. The variable clock signals outputted from the respective variable clock generators 24-1, 24-2, . . . , 24-N are inputted to the N×N switch matrix 18 which switches the variable clock signals.

To the test controllers 10-1, 10-2, . . . , 10-N, the test pin groups 12-1, 12-2, . . . , 12-N are assigned on-line via the N×N switch matrix 16 which switches the control signals and the N×N switch matrix 18 which switches the variable clock signals. To the test pin group 12-j (j is a natural number which satisfies 1≦j≦N) assigned to the test controller 10-i (i is a natural number which satisfies 1≦i≦N) one-to-one, the control signal from the test controller 10-i, which is synchronized with the fixed clock signal, is supplied via the N×N switch matrix 16, while the variable clock signal from the variable clock generator 24-i associated with the test controller 10-i is supplied via the N×N switch matrix 18. The assignment of the test pin groups 12-1, 12-2, . . . , 12-N to the test controllers 10-1, 10-2, . . . , 10-N is changed by switching the control signals by the N×N switch matrix-16 and switching the variable clock signals by the N×N switch matrix 18.

The pin electronics cards 20 of the test pin groups 12-1, 12-2, . . . , 12-N each include a pattern generator (not illustrated) and a timing generator (not illustrated) for generating a test signal of a prescribed waveform at a prescribed timing to be inputted to the DUTs, and test the DUTs as to the normality, etc. The pin electronics cards 20 of the test pin group 12-j test the DUTs, based on the control signal from the assigned test controller 10-i. To the pin electronics cards 20 of the test pin group 12-j, the variable clock signal from the variable clock generator 24-i associated with the test controller 10-i is supplied. The test pin cards 20 of the test pin group 12-j operate in synchronization with the variable clock signal from the variable clock generator 24-i.

In the testing apparatus according to the present embodiment, the change of the assignment of the test pin groups 12-1, 12-2, . . . , 12-N to the test controllers 10-2, 10-2, . . . , 10-N is made by, as described above, switching the control signals by the N×N switch matrix 16 and switching the variable clock signals by the N×N switch matrix 18.

When the test pin group assigned to the test controller 10-i is changed from the test pin group 12-i to the test pin group 12-k (k is a natural number which satisfies 1≦k≦N and k≠i), the N×N switch matrices 16, 18 switch as follows. That is, the N×N switch matrix 16 switches so that the control signal from the test controller 10-i is supplied to the pin electronics cards 20 of the test pin group 12-k. At the same time, the N×N switch matrix 18 switches so that the variable clock signal from the variable clock signal generator 24-i associated with the test controller 10-i is supplied to the pin electronics cards 20 of the test pin group 12-k.

As described above, in the testing apparatus according to the present embodiment, the control signals are switched by the N×N switch matrix 16 while the variable clock signals are switched by the N×N switch matrix 18, whereby even when an assignment change is made, the variable clock signal from the variable clock generator 24-i associated with the test controller 10-i is supplied to the pin electronics cards 20 of the test pin group 12-k assigned anew to the test controller 10-i. Thus, the variable clock signal having a certain phase relationship with the control signal always retained can be supplied to the pin electronics cards of the test pin group. Accordingly, the test pin groups can be assigned to the test controllers on-line, and the test controllers can control the assigned test pin groups individually.

In contrast to this, with the test pin groups being formed of the pin electronics cards which synchronize with the variable clock signals, when the controls signals alone are switched without the variable clock signals being switched, the following disadvantage takes place.

FIG. 2 is a block diagram of the structure of the testing apparatus including the test pin groups formed of pin electronics cards which synchronize with the variable clock signals, wherein the control signals alone are switched without the variable clock signals being switched. In FIG. 2, the test pin groups 12-1, 12-2 are assigned to the test controllers 10-1, 10-2.

As illustrated, the control signals from the test controllers 10-1, 10-2 are supplied to the assigned test pin groups 12-1, 12-2 via the N×N switch matrix 16, as are in the structure illustrated in FIG. 1.

On the other hand, the variable clock signal from the variable clock generator 24-1 associated with the test controller 10-1 is supplied as it is to the pin electronics cards 20 of the test pin groups 12-1. The variable clock signal from the variable clock generator 24-2 associated with the test controller 10-2 is supplied as it is to the pin electronics cards 20 of the test pin groups 12-2. Thus, the route of the clocks in the structure illustrated in FIG. 2 is fixed, as is not in the structure illustrated in FIG. 1.

In the structure illustrated in FIG. 2, in which the route of the variable clock signals from the variable clock generators 24-1, 24-2 is fixed, when the test pin groups 12-1 is assigned to the test controller 10-1, the variable clock signal having a certain phase relationship with the control signal retained can be supplied to the pin electronics cards 20 of the test pin groups 12-1.

However, in the structure illustrated in FIG. 2, when the test pin groups 12-2 is assigned to the test controller 10-1, it is difficult to retain the phase relationship between the control signal and the variable clock signal. In this case, the control signal from the test controller 10-1 is switched by the N×N switch matrix 16 to be supplied to the pin electronics cards 20 of the test pin group 12-2. However, to the pin electronics cards 20 of the test pin group 12-2, the variable clock signal from the variable clock generator 24-1 associated with the test controller 10-1 is not supplied, but the variable clock signal from the variable clock generator 24-2 associated with the test controller 10-2 is supplied.

FIG. 3 is a time chart of the control signal and the variable clock signal supplied to the pin electronics cards 20 of the test pin group 12-2 when the test pin group 12-2 is assigned to the test controller 10-1.

As illustrated, when the period of the fixed clock signal the control signal synchronizes with is, e.g., 4 ns, and the period of the variable clock signal is, e.g., 5 ns, the phase difference between the control signal and the variable clock signal supplied to the pin electronics cards 20 of the test pin group 1.2-2 changes in the unit of mod(5 ns, 4 ns)=1 ns. For example, as illustrated, the phase difference becomes 0.5 ns, 1.5 ns, 3.5 ns, 0.5 ns, 1.5 ns, . . . repeatedly and changes in the unit of 1 ns. Here, the control signal from the test controller 10-1 are asynchronous with the variable clock signal from the variable clock generator 24-2 associated with the test controller 10-2. Accordingly, there is a possibility that the control signal to be supplied to the pin electronics cards 20 of the test pin group 12-2 might be supplied in an arbitrary cycle which is not related with the variable clock signal to be supplied. Resultantly, it becomes difficult to retain the phase relationship between the control signal and variable clock signal to be supplied to the pin electronics cards 20 of the test pin group 12-2.

In testing apparatus according to the present embodiment, the control signals are switched by the N×N switch matrix 16 while the variable clock signals are switched by the N×N switch matrix 18 to assign the test pin groups 12-1, 12-2, . . . , 12-N to the test controllers 10-1, 10-2, . . . , 10-N, whereby the phase relationship between the control signals and variable clock signals to be supplied to the pin electronics cards of the test pin groups can be always retained. Thus, the test pin groups can be assigned on-line to the test controllers, and the test controllers can control the assigned test pin groups individually.

### Modified Embodiments

The present invention is not limited to the above-described embodiment and can cover other various modifications.

For example, in the above-described embodiment, the test pin groups are assigned to the test controllers one-to-one. However, the test pin groups may be assigned to the controller one-to-n (n is a natural number which satisfies 1≦n≦N) via the N×N switch matrices 16, 18. In this case, to the respective pin electronics cards of n test pin groups assigned to the test controller 10-i one-to-n, the control signal from the test controller 10-i, which is synchronized with the fixed clock signal, is supplied via the N×N switch matrix 16 while the variable clock signal from the variable clock generator 24-i associated with the test controller 10-i is supplied via the N×N switch matrix 18. Thus, the variable clock signal having a certain phase relationship with the control signal always retained can be supplied to the pin electronics cards of the n test pin groups assigned to the test controller 10-i.

What is claimed is:

1. A testing apparatus for semiconductor device comprising:
a plurality of controlling units which output control signals for testing devices under test;
a plurality of variable clock generating units provided respectively associated with said plural controlling units, for outputting variable clock signals having certain phase relationships with the control signals outputted from the associated controlling units;
a testing unit for testing the device under test based on the control signal, the testing unit synchronizing with the variable clock signal;
a first switching means for supplying the control signal from one controlling unit of the plural controlling units to the testing unit which is assigned to said one controlling unit; and
a second switching means for supplying to the testing unit the variable clock signal from one variable clock generating unit of the plural variable clock generating units, said one variable clock generating unit being associated with said one controlling unit.

2. A testing apparatus for semiconductor device according to claim 1, which comprises
a plurality of said testing units, and in which
one testing unit of said plural testing units is assigned to said one controlling unit,
the first switching means supplies to said one testing unit the control signal from said one controlling unit, and
the second switching means supplies to said one testing unit the variable clock signal from said one variable clock generating unit.

3. A testing apparatus for semiconductor device according to claim 1, which comprises
a plurality of said testing units, and in which
said plural testing units are assigned to said one controlling unit,
the first switching means supplies to said plural testing units the control signal from said one controlling unit, and
the second switching means supplies to said plural testing units the variable clock signal from said one variable clock generating unit.

4. A testing apparatus for semiconductor device according to claim 1, wherein
the first switching means and the second switching means are respectively switch matrices having a plurality of inputs and a plurality of outputs.
